(19) United States
(12) Patent Application Publication
(10) Pub. No.: US 2012/0316742 A1
(43) Pub. Date: Dec. 13, 2012

(54) METHOD FOR CONTROLLING A FRICTION CLUTCH

(75) Inventor: Artur Schlappa, Karlsruhe (DE)

(73) Assignee: SCHAEFFLER TECHNOLOGIES AG & CO. KG, Herzogenaurach (DE)

(21) Appl. No.: 13/587,457

(22) Filed: Aug. 16, 2012

Related U.S. Application Data
(63) Continuation of application No. PCT/DE2011/000116, filed on Feb. 7, 2011.

(30) Foreign Application Priority Data
Feb. 18, 2010 (DE) 10 2010 008 442.5

(51) Int. Cl. F16D 48/06

(52) U.S. Cl. 701/68

(57) ABSTRACT

The invention relates to a method for controlling a friction clutch, or two friction clutches provided in a double clutch transmission, for transmitting torque provided by an internal combustion engine to a transmission in a motor vehicle. A clutch actuator friction locks friction linings of the friction clutch in an operating mode by specifying an actuation path to transmit the torque provided by the internal combustion engine and to compensate for an extended additional path in the friction clutch from the wear of the friction linings in that the clutch actuator specifies the extended shift travel in comparison to the actuation path, wherein an adjusting process is triggered with compensation for the additional path when wear of the friction clutch exists. To regularly execute in the adjusting process, it is proposed to initiate the shifting path depending on a distance traveled by the motor vehicle since a previous adjusting process.

### CROSS-REFERENCE TO RELATED APPLICATIONS

This application is filed under 35 U.S.C. §120 and §365(c) as a continuation of International Patent Application No. PCT/DE2011/000116, filed Feb. 7, 2011 which application claims priority of German Patent Application No. DE 10 2010 008 442.5, filed Feb. 18, 2010, which applications are incorporated herein by reference in their entireties.

### FIELD OF THE INVENTION

The invention relates to a method for controlling a friction clutch, or two friction clutches provided in a double clutch transmission, for transmitting torque provided by an internal. combustion engine to a transmission in a motor vehicle. A clutch actuator friction locks friction linings of the friction clutch in an operating mode by specifying an actuation path to transmit the torque provided by the internal combustion engine and to compensate for an extended additional path in the friction clutch from the wear of the friction linings of the friction clutch in that the clutch actuator specifies an extended shift travel in comparison to the actuation path. An adjusting process is triggered with compensation for the additional path when there is wear of the friction clutch.

### BACKGROUND OF THE INVENTION

Automatic friction clutches that are known from the prior art are formed from a thrust plate connected in a non-rotatable manner to the crankshaft of an internal combustion engine and a pressure plate axially displaceable thereto, between which friction linings of a transmission-side, non-rotatably connected clutch disks are engaged by friction. The pressure plate is displaced by a clutch actuator toward the thrust plate so that, depending on the travel path, a torque transmissible by the friction clutch arises, and the friction clutch is engaged through a slipping state. A transmissible torque is continually set in the friction clutch along the actuation path set by the clutch actuator that is slightly above the torque provided by the internal combustion engine (torque adjusting).

During the operating time of the friction clutch, the friction linings engage so that, with reference to the torque transmissible by the friction clutch, an additional path is required that can cause problematic operating conditions of the friction clutch and/or the clutch actuator. Friction clutches are therefore used that compensate for the additional path. When wear is recognized, compensation can be provided in steps by rotating a ramp device during which the pressure plate tracks the wear of the clutch linings. Wear can be established, for example, in a path-dependent manner by detecting the additional path or in a force-dependent manner by evaluating the increased actuation force based on unfavorable actuation force arising from the operating conditions of the friction clutch altered by wear. The adjusting function of such a friction clutch can be found, for example, in the form of two friction clutches combined into a double clutch in WO 2008/058 508 A1 in which both friction clutches have an adjusting device.

A friction clutch with an automated clutch actuator controlled by a control unit can be actuated so that it is actuated for a shift travel longer than the actuation path, during which the friction clutch transmits the maximum transmissible torque. Due to the arising longer shift travel or the force that this requires when there is wear, a path or force sensor in the friction clutch releases fix the ramp device to compensate for the additional path. Under normal operating conditions of the friction clutch or internal combustion engine, the actuation path corresponding to the shift travel is only initiated in response to extreme requests by the driver, or when the motor vehicle is at a standstill. The adjusting process of a standing motor vehicle can be impaired or blocked by friction torque, inhibitions, etc. of the adjusting device when the internal combustion engine is turned off

### BRIEF SUMMARY OF THE INVENTION

The object of the invention is therefore to develop a method for operating a friction clutch having an improved routine for performing adjusting processes to compensate for the wear of friction linings.

The object is achieved by a method for controlling a friction clutch for transmitting torque provided by an internal combustion engine to a transmission in a motor vehicle, during which a clutch actuator friction locks friction linings of the friction clutch in an operating mode by specifying an actuation path to the extent that the torque provided by the internal combustion engine is transmitted, and an extended additional path in the friction clutch from the wear of the friction linings of the friction clutch is compensated in that the clutch actuator specifies an extended shift travel in comparison to the actuation path, in the course of which an adjusting process is triggered with compensation for the additional path when there is wear of the friction clutch, and the shifting path is initiated depending on a distance traveled by the motor vehicle since a previous adjusting process.

A friction clutch is to be understood as an individual friction clutch or two combined into a double clutch. The friction clutch is preferably disengaged or self-disengaging when the clutch actuator is in a force-free state and is actively engaged by the clutch actuator, for example, by being pressed or drawn together. The friction clutch transmits the torque set by the internal combustion engine depending on the driver's desired torque by correspondingly engaging the friction clutch by means of the clutch actuator so that no, or only desired, slip is set, for example to dampen vibration, between the friction linings of the clutch disk and the thrust and pressure plate of the friction clutch. When only one friction clutch is used, a “transmission” is to be understood in particular as a manual or automated transmission. When a double clutch is used in which both friction clutches can be subject to the proposed procedure, the transmission is in particular a double clutch transmission with two partial drivetrains, wherein one of the two friction clutches is assigned to a partial drivetrain so that the gears engaged in the partial drivetrains can be shifted from one to the other friction clutch without an interruption of traction due to a change in torque.

When adjusting is necessary, the adjustment can be roughly calculated from the actuation of the shifting position depending on the distance traveled by the motor vehicle. It is, however, preferable to actuate the shifting position when the motor vehicle is moving. When the internal combustion engine is operating; the arising vibrations will in all likelihood instigate any existing static friction, jamming or inhibition of the adjusting device which makes it more probable that adjusting will be necessary in this operating state. The amount of distance traveled can be specified as a distance threshold that can depend on the vehicle and/or the friction clutch load situation. Therefore, parameters such as the continuously detected driver behavior, exterior temperature, use of a trailer, continuously detected overall speed, etc. can be included in the vehicle threshold.

A routine can be saved in the control unit controlling the clutch actuator or another control unit in which the activation of the shift travel by the clutch actuator depends on the current speed when the distance threshold is reached. It is preferable to specify higher speeds of the internal combustion engine for the adjusting process and hence an initiation of the shift travel. When the distance threshold is reached, the shift travel can be initiated or delayed if, or until, the speed of the internal combustion engine exceeds a specified speed threshold. The speed threshold can be specified depending on the characteristics of the internal combustion engine, for example its vibration behavior, etc., on the design of the friction clutch, especially its adjusting device, etc., and can for example be adapted to changes in the friction clutch, internal combustion engine, etc. over the life of the motor vehicle.

The distance until the first adjustment, or between two adjustments, can for example be measured in the form of the distance threshold depending on the speed of the internal combustion engine when the previous adjustment is executed. This means that the speed of the internal combustion engine in a new motor vehicle or new friction clutch is specified and saved during the following adjustments, and a distance threshold is established for the following adjustment depending on this speed. The speed-dependent distance thresholds can be specified depending on the properties of the internal combustion engine. It has proven to be advantageous to increasingly set the distance as the speed increases: i.e. the distance until the next time the shift travel is initiated when adjusting at a lower speed is less than when initiating the shift travel at a greater speed.

If the distance is reached at which the shift travel is to be initiated and the set speed threshold has not been reached or has been exceeded, the initiation of the shift travel is delayed until the speed threshold is exceeded. This takes into account that, given very moderate driving at low speeds, the shift travel is initiated at distances close to the reached distance as at the specified distance threshold since the speed threshold is lowered as a function of the increasing distance when the speed is not exceeded.

According to an embodiment, the method for controlling two friction clutches that transmit the torque of the internal combustion engine to two partial drivetrains, each with at least one gear shifting a transmission ratio, is used for both friction clutches. The shift travel of a friction clutch can be initiated during an operating state in which torque is not being transmitted and a gear is not engaged, and when torque is being transmitted by increasing the actuation path of the provided torque to the shift travel for maximum transmissible torque.

### BRIEF DESCRIPTION OF THE DRAWINGS

The invention will be further explained with reference to the exemplary embodiments in FIGS. 1 to 3, Various embodiments are disclosed, by way of example only, with reference to the accompanying schematic drawings in which corresponding reference symbols indicate corresponding parts, in which:

FIG. 1 is an exemplary embodiment of a method as a flowchart;

FIG. 2 is a graph of the adjustment of the distance as a function of the speed of the internal combustion engine during the previous adjustment; and,

FIG. 3 is a graph of the reduction of a speed threshold during an adjustment when the speed threshold is not reached.

### DETAILED DESCRIPTION OF THE INVENTION

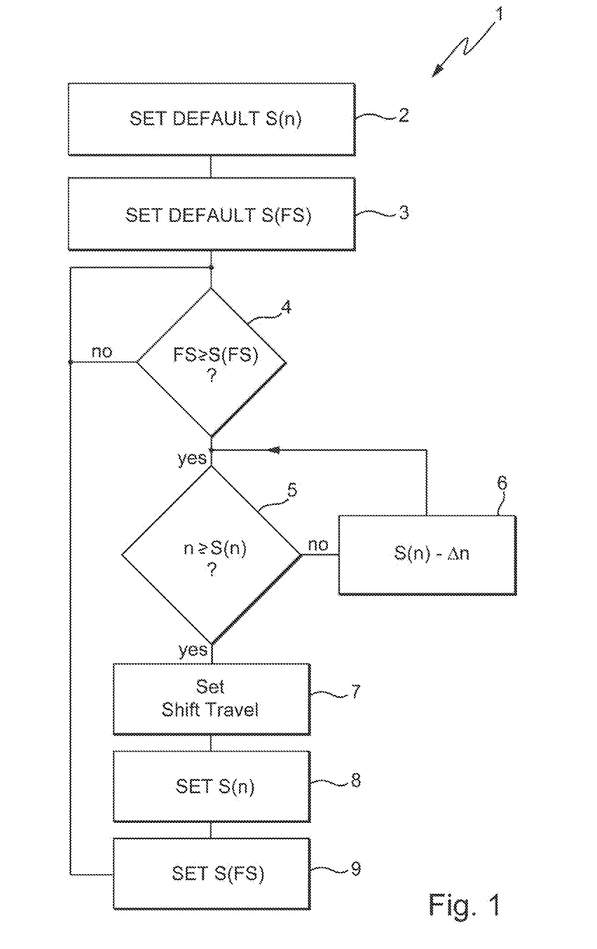

FIG. 1 shows flowchart 1 to schematically illustrate a method for controlling a friction clutch adjustment process. Of course, the routine on which flowchart 1 is based can be executed in a control unit simultaneous or sequential to other routines for controlling the friction clutch and depending on the selected source code. The flowchart should therefore only be interpreted as a schematic.

A routine on which flowchart 1 is based starts in block 2 with a preliminary establishment of threshold S(n) for speed n of the internal combustion engine while the shift travel of the friction clutch is initiated by the actuator during which adjustment occurs, assuming that the conditions for the travel or path sensors of the friction clutch adjustment device have been satisfied up to the point of the shift travel. In block 3, preliminary threshold S(FS) for distance FS of the motor vehicle with the friction clutch is correspondingly specified.

At branch 4, a check occurs to see if current distance ES reaches or exceeds threshold S(FS). If this is not the case, another check occurs in branch 4, possibly after waiting a specified time. if threshold S(FS) has been reached, a check occurs in branch 5 to see if threshold S(n) has reached or exceeded speed n of the internal combustion engine. If this is not the case, threshold S(n) is reduced by specified differential speed An which is preferably a fraction of threshold S(n), possibly after a specified time or distance, and it is rechecked in branch 5. If applicable, this is carried out in a loop until the minimum speed n satisfies the condition of branch 5, and the shift travel is set by the clutch actuator in block 7 as is the case when branch 5 is satisfied at the beginning. If the condition for readjustment of the path or force sensors of the friction clutch is satisfied, readjustment occurs; otherwise it does not.

While the shift travel is being set, speed n of the internal combustion engine is detected and archived, e.g., saved in block 8 as a new threshold S(n). Threshold S(FS) is calculated from speed n or threshold 5(n) according to a mathematical function or from the saved characteristics, and it is also saved. Then distance ES is continuously checked against threshold S(FS) at predetermined intervals of time and/or distance in branch 4. Flowchart 1 is therefore run through again irrespective of blocks 2 and 3.

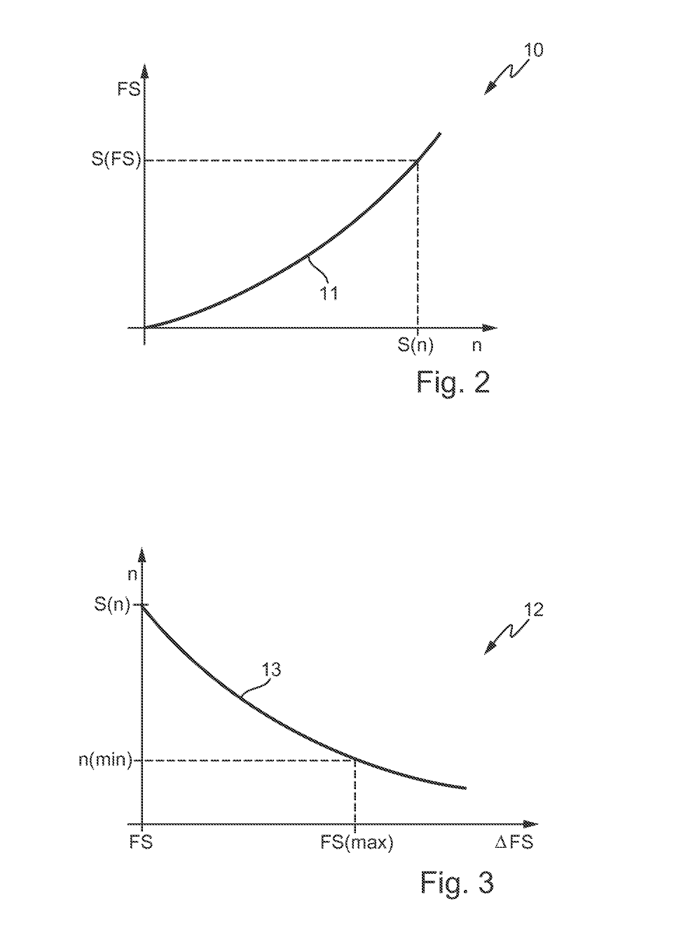

FIG. 2 shows graph 10 of distance FS of the motor vehicle in comparison to speed n. Curve 11 provides an exemplary embodiment of the dependency of the specified threshold S(FS) on threshold S(r) of speed n of the internal combustion engine while starting the shift travel of the friction clutch. If speed n and, therefore, the set threshold S(n) are high, threshold S(FS) is at a correspondingly high level. If the shift travel starts at low speeds n, distance FS correspondingly drops until the shift travel is restarted.

FIG. 3 shows graph 12 of speed n plotted against differential distance ΔFS when starting the shift travel when threshold S(n) has not been reached. According to the exemplary embodiment of curve 13, speed n decreases as differential distance ΔFS increases until minimum speed n(min) is reached at maximum distance FS(max), if applicable, at which the shift travel begins at all events. If speed n decreases corresponding to curve 13, a correspondingly reduced threshold S(n) with a correspondingly shortened threshold S(FS) (FIGS. 1 and 2) are provided for the distance for the next shift travel; the distance until the next time the shift travel starts is hence reduced.

### LIST OF REFERENCE NUMBERS

1 Flowchart
2 Block
3 Block
4 Branch
5 Branch
6 Block
7 Block
8 Block
9 Block
10 Graph
11 Curve
12 Graph
13 Curve
ΔFS Differential distance
Δn Differential speed
FS Distance
FS(max) Maximum distance
n Rotational speed
n(min) Minimum speed
S(FS) Distance threshold
S(n) Speed threshold

What is claimed is:

1. A method for controlling a friction clutch for transmitting a torque provided by an internal combustion engine to a transmission in a motor vehicle, the method comprising the steps of:
specifying an actuation path to an extent that the torque provided by the internal combustion engine is transmitted;
locking a plurality of friction linings of the friction clutch in an operating mode frictionally with a clutch actuator;
specifying an extended shift travel in comparison to the actuation path with the clutch actuator;
triggering an adjusting process to compensate for an extended additional path in the friction clutch from the wear of the friction linings of the friction clutch; and,
initiating a shifting path depending on a distance traveled (FS) by the motor vehicle since a previous adjusting process.

2. The method as recited in claim 1, wherein the shift travel is initiated when a speed (n) of the internal combustion engine exceeds a specifiable speed threshold (S(n)).

3. The method as recited in claim 2, wherein, after the traveled distance (FS) is reached, the shift travel is initiated a next time the speed threshold (S(n)) is exceeded.

4. The method as recited in claim 3, wherein, when the speed (n) is not exceeded, the speed threshold (S(n)) is reduced depending on an increasing differential distance (ΔFS).

5. The method as recited in Claim I, wherein the distance (FS) is measured depending on a speed (n) of the internal combustion engine when performing the previous adjusting process.

6. The method as recited in claim 5, wherein the distance (FS) is correspondingly increased as the speed (n) of the internal combustion engine increases during the previous adjusting process.

7. The method as recited in claim 1 for controlling the torque of an internal combustion engine in two partial drivetrains, each partial drivetrain comprising at least one gear shifting a transmission ratio of transmitting friction clutches.

8. The method as recited in claim 7, wherein the shift travel of a friction clutch is initiated in the operating state in which torque is not transmitted when the gear is not engaged.

9. The method as recited in claim 7, wherein the shift travel of a friction clutch is initiated in the transmitting-torque state in that the actuation path of the provided torque is increased to the shift travel in the case of maximum transmissible torque.
